(19) United States
(12) Patent Application Publication
(10) Pub. No.: US 2026/0025471 A1
(43) Pub. Date: Jan. 22, 2026

(54) INSPECTION SYSTEM, INSPECTION METHOD, AND NON-TRANSITORY RECORDING MEDIUM

(71) Applicant: Daisuke ANAN, Kanagawa (JP)

(72) Inventor: Daisuke ANAN, Kanagawa (JP)

(21) Appl. No.: 19/263,498

(22) Filed: Jul. 9, 2025

(30) Foreign Application Priority Data
Jul. 18, 2024 (JP) 2024-114572

(51) Int. Cl. H04N 1/00; G06F 3/12

(52) U.S. Cl. CPC H04N 1/0044; G06F 3/1208; G06F 3/1256; H04N 1/00005; H04N 1/00037; H04N 1/00079

(57) ABSTRACT

An inspection system includes an image forming apparatus to form an image on a printed matter and an inspection apparatus to detect a defect of the printed matter. The image forming apparatus has a display to display the defect and circuitry. The display displays the defect. The circuitry changes a detection level of the defect at the display. The circuitry sets a change of the detection level. The circuitry reflects a setting result of the detection level on the inspection apparatus without interrupting operation of the image forming apparatus.

### CROSS-REFERENCE TO RELATED APPLICATION

This patent application is based on and claims priority pursuant to 35 U.S.C. § 119(a) to Japanese Patent Application No. 2024-114572, filed on Jul. 18, 2024, in the Japan Patent Office, the entire disclosure of which is hereby incorporated by reference herein.

### BACKGROUND

### Technical Field

The present disclosure relates to an inspection system, an inspection method, and a non-transitory recording medium.

### Related Art

In order to facilitate a user's operation of checking whether there is a problem in quality of an output image, a technique has been proposed in which a document image and a read image (an image obtained by reading an output image) are compared with each other, and a defect detection report is output.

In a technique of inspecting a printed matter by an image forming apparatus, even when a user checks a detection result of a defect in the middle of printing and there is no problem in quality, printing cannot be restarted unless the detection level or a non-detection range is reset. The setting of the detection level or the non-detection range may be performed after the printing is interrupted. This reduce productivity, and the user needs to check how many sheets have been successfully printed. It is also difficult for the user to inspect the printed matter (detect, e.g., a defect) at an ideal detection level.

### SUMMARY

The present disclosure described herein provides an inspection system. The inspection system includes an image forming apparatus to form an image on a printed matter and an inspection apparatus to detect a defect of the printed matter. The image forming apparatus has a display to display the defect and circuitry. The display displays the defect. The circuitry changes a detection level of the defect at the display. The circuitry sets a change of the detection level. The circuitry reflects a setting result of the detection level on the inspection apparatus without interrupting operation of the image forming apparatus.

The present disclosure described herein provides an inspection method. The inspection method includes displaying, on a display, a defect of a printed matter formed by an image forming apparatus, the defect being detected by an inspection apparatus. The inspection method includes changing a detection level of the defect. The inspection method includes setting a change of the detection level. The inspection method includes reflecting a setting result of the detection level on the inspection apparatus without interrupting operation of the image forming apparatus.

The present disclosure described herein provides a non-transitory recording medium storing a plurality of instructions which, when executed by one or more processors, causes the one or more processors to perform an inspection method. The inspection method includes displaying, on a display, a defect of a printed matter formed by an image forming apparatus, the defect being detected by an inspection apparatus. The inspection method includes changing a detection level of the defect. The inspection method includes setting a change of the detection level. The inspection method includes reflecting a setting result of the detection level on the inspection apparatus without interrupting operation of the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an inspection system to which an inspection apparatus is connected;

FIG. 2 is a diagram illustrating a hardware configuration of a printer (inkjet printer);

FIG. 3 is a diagram illustrating a hardware configuration of a multifunction peripheral (MFP);

FIG. 4 is a diagram illustrating a configuration of a digital front end (DFE);

FIG. 5 is a diagram illustrating a configuration of a printer;

FIG. 6 is a diagram illustrating a configuration of an inspection apparatus;

FIG. 7 is a flowchart illustrating an inspection process executed by an inspection apparatus;

FIG. 8 is a diagram illustrating processing for allowing a user to select a method of recommending or automatically executing interruption of printing and maintenance for a specific defect by using machine learning in an inspection apparatus;

FIG. 9 is a diagram illustrating a UI when an inspection level changing process and a non-detection range setting process are performed in an inspection apparatus;

FIG. 10-1 is a diagram illustrating a process of changing a detection level in an inspection apparatus;

FIG. 10-2 is a diagram illustrating a process of changing a detection level in an inspection apparatus;

FIG. 10-3 is a diagram illustrating a process of changing a detection level in an inspection apparatus;

FIG. 11-1 is a diagram illustrating a process of setting a non-detection range in an inspection apparatus;

FIG. 11-2 is a diagram illustrating a process of setting a non-detection range in an inspection apparatus; and

FIG. 12 is a diagram illustrating a screen of a detection log of a defect of an inspection apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of an inspection system, an inspection method, and a program for controlling inspection are described in detail below, with reference to the accompanying drawings.

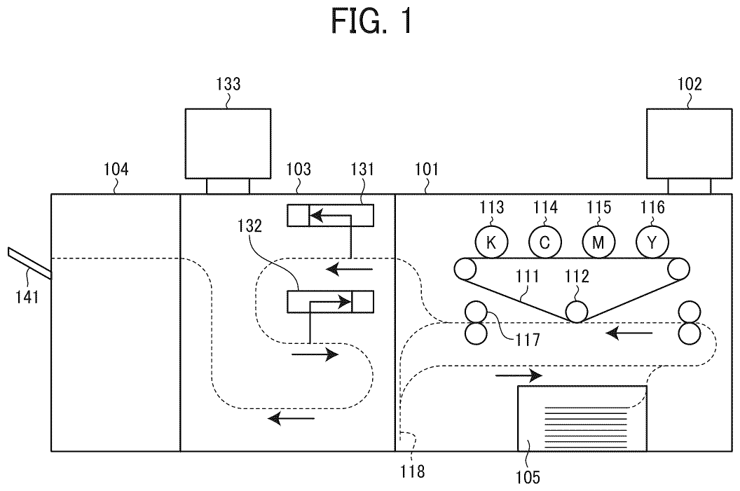

FIG. 1 is a diagram illustrating a configuration of an inspection system to which an inspection apparatus is connected. The inspection system includes a printer 101, which is an example of an image forming apparatus that forms an image on a printed matter, and an operation unit 102.

The printer 101 receives print information (print job) including a print image (raster image processor (RIP) image) from the outside, or receives an instruction to execute a print job stored in the printer 101. The printer 101 further acquires a sheet from a sheet feeding unit 105 according to the print job, and conveys the sheet along a path indicated by a dotted line in FIG. 1. The printer 101 forms toner images of K (black), C (cyan), M (magenta), and Y (yellow), respectively on the surfaces of drums 113, 114, 115, and 116. The toner images of K, C, M, and Y are superimposed on a belt 111 to form a composite toner image as the belt 111 rotates, and the composite toner image on the belt 111 is transferred to the sheet conveyed along the path at a roller 112. The composite toner image is fixed on the sheet by a roller pair 117, and the sheet having the toner image formed thereon is ejected to an inspection apparatus 103 in the case of single sided printing. In the case of double sided printing, the print sheet is reversed in a reversing path 118 to be transferred again to the roller 112. The composite toner image is transferred and fixed on the opposite side of the sheet, and the sheet is ejected.

The inspection apparatus 103 detects a defect of the print sheet (one example of a printed matter) that is the sheet output by the printer 101, and includes an operation unit 133 that displays the defect detected by the inspection apparatus 103. The inspection apparatus 103 may not include the operation unit 133, and the operation unit 102 of the main body of the printer 101 may also serve as the operation unit 133. The inspection apparatus 103 may be a personal computer (PC) connected to the printer 101 via a local area network (LAN). The inspection apparatus 103 reads both sides of the print sheet ejected from the printer 101 by reading devices 131, and 132 each implemented by a line sensor, and ejects the print sheet. A stacker 104 stacks the print sheet ejected from the inspection apparatus 103 on a tray 141. In the present system, the RIP image is an image having 600 dpi with the color channels of CMYK each having 8 bits of data, and the read image is an image having 200 dpi with the color channels of RGB each having 8 bits of data.

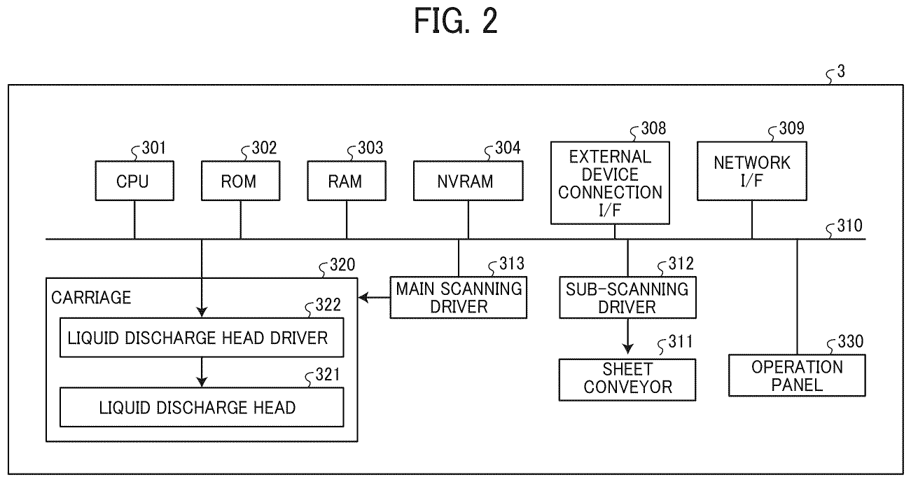

A hardware configuration of an inkjet printer 3, which is one example of the printer 101, is described with reference to FIG. 2. FIG. 2 is a diagram illustrating a hardware configuration of the inkjet printer 3. As illustrated in FIG. 2, the inkjet printer 3, which is an example of the liquid discharge apparatus, includes a central processing unit (CPU) 301, a read-only memory (ROM) 302, a random-access memory (RAM) 303, a nonvolatile random-access memory (NVRAM) 304, an external device connection interface (I/F) 308, a network I/F 309, and a bus line 310.

The inkjet printer 3 further includes a sheet conveyor 311, a sub-scanning driver 312, a main scanning driver 313, a carriage 320, and an operation panel 330 (one of the operation units 102). The carriage 320 further includes a liquid discharge head 321 and a liquid discharge head driver 322.

The CPU 301 controls the overall control of the inkjet printer 3. The ROM 302 stores a software program used for executing the CPU 301 such as an initial program loader (IPL). The RAM 303 is used as a working area for the CPU 301. The NVRAM 304 stores various kinds of data such as a control program, such that the data is kept stored even when the power of the inkjet printer 3 is cut off. The external device connection I/F 306 is connected to a PC via, e.g., a universal serial bus (USB) cable to transmit or receive control signals to or from the PC, or transmit data to be printed to the PC. The network I/F 309 is an interface for communicating with a communication network such as the Internet. The bus line 310 includes an address bus and a data bus. The bus line 310 electrically connects the components, such as the CPU 301, with each other.

The sheet conveyor 311 is, e.g., a roller and a motor that drives the roller, and conveys the print sheet in the sub-scanning direction along a conveyance path in the inkjet printer 3. The sub-scanning driver 312 controls the movement of the sheet conveyor 311 in the sub-scanning direction. The main scanning driver 313 controls the movement of the carriage 320 in the main scanning direction.

The liquid discharge head 321 of the carriage 320 has a plurality of nozzles for discharging liquid such as ink, and is mounted on the carriage 320 so that its discharge surface (nozzle surface) faces a side of the print sheet. While moving in the main scanning direction, the liquid discharge head 321 discharges the liquid onto the print sheet conveyed intermittently in the sub-scanning direction. Specifically, the liquid discharge head 321 discharges the liquid onto a predetermined position of the printing sheet to form an image on the printing sheet. The liquid discharge head driver 322 is a driver for controlling driving of the liquid discharge head 321.

The operation panel 330 (one example of the operation unit 102) includes, for example, a touch panel and one or more alarm lamps. The touch panel displays current settings or a selection screen, and receives user inputs.

The liquid discharge head driver 322 may be connected to the bus line outside the carriage 320 without being mounted on the carriage 320. The main scanning driver 313, the sub-scanning driver 312, and the liquid discharge head driver 322 may operate according to the commands of the CPU 301 executed according to a program, and in another example, their functions may be partly executed by the CPU 301.

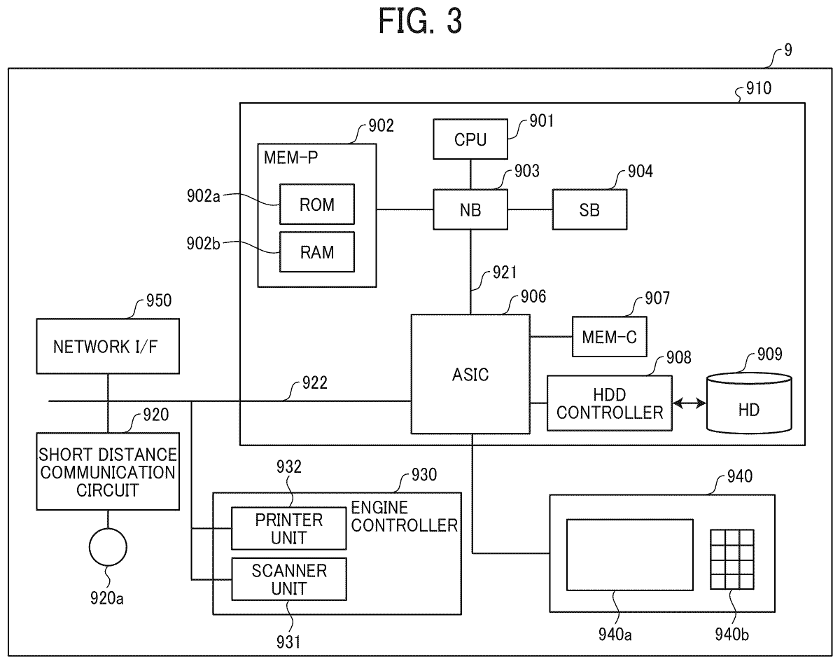

A hardware configuration of a multifunction peripheral (MFP), which is another example of the printer 101, is described with reference to FIG. 3. The MFP may be also referred to as a multifunction product or printer. FIG. 3 is a diagram illustrating a hardware configuration of an MFP 9 according to the present embodiment. As illustrated in FIG. 3, the MFP 9 includes a controller 910, a short-range communication circuit 920, an engine controller 930, an operation panel 940 (one of the operation units 102), and a network I/F 950.

The controller 910 includes a CPU 901 as a main processor, a system memory (MEM-P) 902, a north bridge (NB) 903, a south bridge (SB) 904, an application-specific integrated circuit (ASIC) 906, a local memory (MEM-C) 907 as a storage, a hard disk drive (HDD) controller 908, and an HD 909 as a storage. An accelerated graphics port (AGP) bus 921 connects the NB 903 and the ASIC 906.

The CPU 901 controls the overall operation of the MFP 9. The NB 903 connects the CPU 901 to the system memory 902, the SB 904, and the AGP bus 921. The NB 903 includes a memory controller that controls the reading or writing of various data from or to the system memory 902, a peripheral component interconnect (PCI) master, and an AGP target.

The MEM-P 902 includes a ROM 902a as a memory that stores a program and data for implementing various functions of the controller 910. The MEM-P 902 further includes a RAM 902b as a memory that deploys a program and data, or as a drawing memory that stores drawing data for printing. The program stored in the RAM 902b may be stored in any computer-readable storage medium, such as a compact disc-read-only memory (CD-ROM), a compact disc-recordable (CD-R), or a digital versatile disc (DVD), in a file format installable or executable by the computer, for distribution.

The SB 904 is a bridge that connects the NB 903 with a PCI device or a peripheral device. The ASIC 906 is an integrated circuit (IC) dedicated to image processing, which has hardware elements for image processing, and connects the AGP bus 921, a PCI bus 922, the HDD controller 908, and the MEM-C 907 with one another. The ASIC 906 includes a PCI target, an AGP master, an arbiter (ARB) as a central processor of the ASIC 906, a memory controller for controlling the MEM-C 907, a plurality of direct memory access controllers (DMACs) capable of converting coordinates of image data with a hardware logic, and a PCI unit that transfers data between a scanner unit 931 and a printer unit 932 through the PCI bus 922. Note that a USB interface or the Institute of Electrical and Electronics Engineers (IEEE) 1394 interface may be connected to the ASIC 906.

The MEM-C 907 is used as a buffer for an image to be copied or a buffer for coding. The HD 909 is a storage (memory) that stores various image data, font data for printing, and form data. The HD 909 reads or writes various data from or to the HD 909 under control of the CPU 901. The AGP bus 921 is a bus interface for a graphics accelerator card, which has been proposed to accelerate graphics processing. Through directly accessing the MEM-P 902 by high-throughput, the speed of the graphics accelerator card increases.

The short-range communication circuit 920 is provided with a short-range communication antenna 920a. The short-range communication circuit 920 is a communication circuit that communicates in compliance with, for example, the near field communication (NFC) or the BLUETOOTH.

The engine controller 930 includes the scanner unit 931 and the printer unit 932. The control panel 940 (one of the operation units 102) includes a panel display 940a and an operation device 940b. The panel display 940a is, e.g., a touch panel that displays current settings or a selection screen and that receives a user input. The operation device 940b includes, e.g., a numeric keypad and a start key. The numeric keypad receives assigned values of image forming parameters such as an image density parameter. The start key receives an instruction to start copying. The controller 910 controls the entire operation of the MFP 9. In an example of the operation, the controller 910 controls drawing, communication, or user inputs to the control panel 940. The scanner unit 931 or the printer unit 932 includes an image processing unit such as error diffusion processing and gamma conversion processing.

In response to an instruction to select a specific application through the control panel 940 (one of the operation units 102), e.g., using a mode switch key, the MFP 9 selectively performs a document box function, a copier function, a printer function, and a facsimile function. When the document box function is selected, the MFP 9 operates in a document box mode. When the copier function is selected, the MFP 9 operates in a copy mode. When the printer function is selected, the MFP 9 operates in a printer mode. When the facsimile function is selected, the MFP 9 operates in a facsimile mode.

The network I/F 950 controls communication of data with an external device through the communication network. The short-range communication circuit 920 and the network I/F 950 are electrically connected to the ASIC 906 through the PCI bus 922.

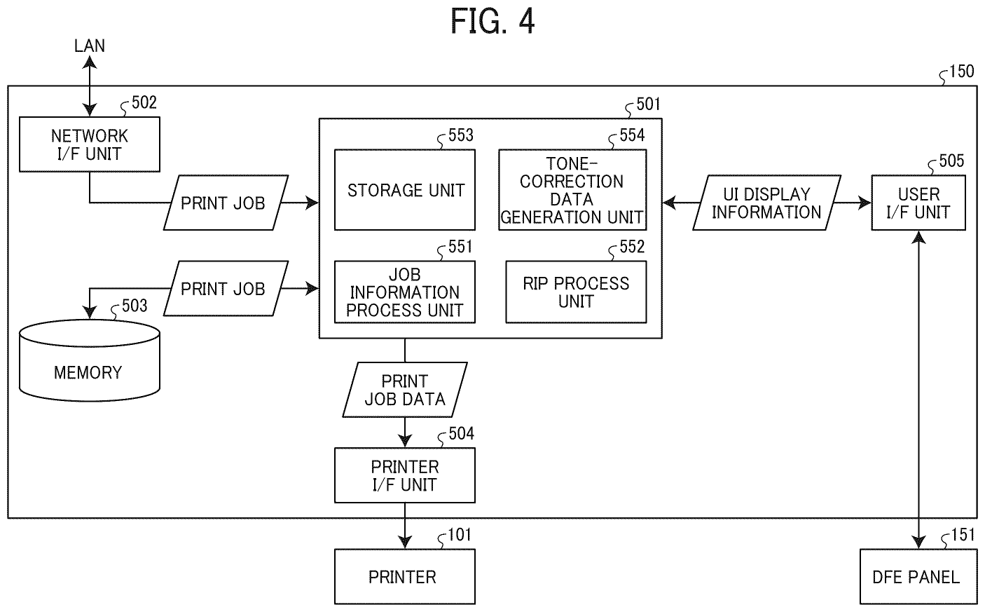

FIG. 4 is a diagram illustrating a configuration of a DFE. The DFE 150 includes, e.g., a system control unit 501, a network I/F unit 502, a storage unit 503, a printer I/F unit 504, and a user I/F unit 505. The DFE 150 is connected to the DFE panel 151 for displaying user interface, and the colorimeter.

The system control unit 501 includes a job information process unit 551, a RIP process unit 552, a memory unit 553, and a tone-correction data generation unit 554. The network I/F unit 502 is an I/F for connection with a LAN. The memory unit 503 in the DFE 150 is a storage device such as an HDD.

The printer I/F unit 504 is an I/F for connecting to the printer 101. The user I/F unit 505 is an I/F with the DFE panel 151. The DFE panel 151 on the DFE 150 is used for inputting and outputting information to and from a user.

The system control unit 501 combines the job management information and the RIP image into a print job, and transmits the print job to the printer 101 via the printer I/F unit 504.

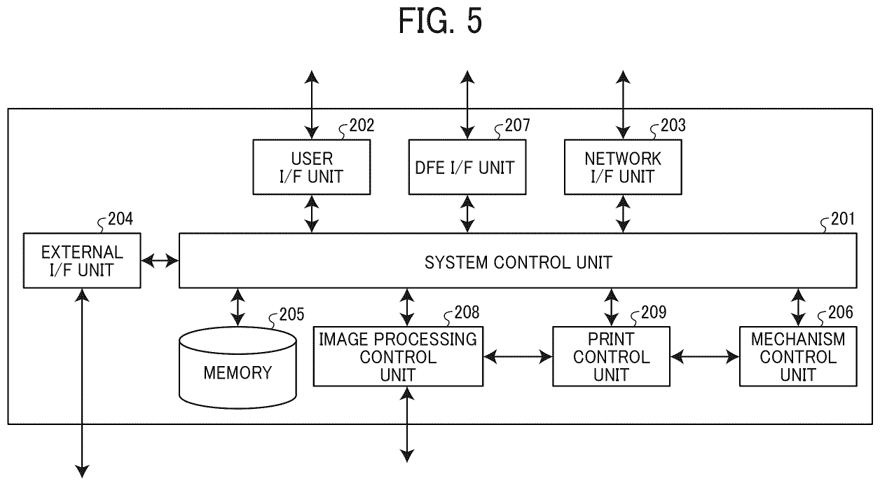

FIG. 5 is a diagram illustrating a configuration of the printer 101. The printer 101 includes, e.g., a system control unit 201, a user I/F unit 202, a network I/F unit 203, an external I/F unit 204, a memory unit 205, a mechanism control unit 206, a DFE I/F unit 207, an image processing control unit 208, and a printing control unit 209. The system control unit 201 is a control unit that controls the entire operation of the printer 101, and includes a memory therein. The user I/F unit 202 is an I/F for connecting the system control unit 201 and the operation unit 102.

A network I/F unit 203 is an I/F for connecting the system control unit 201 to a network such as a LAN. The external I/F unit 204 is an I/F with other devices. The memory unit 205 (e.g., HDD) is a storage device such as a hard disk. The mechanism control unit 206 is a control unit for the operation of the printer 101, such as the sheet conveyance and transfer process performed by the printer 101.

The DFE I/F unit 207 is an I/F for transferring a RIP image to an image generation controller (e.g., DFE 150) connected to the outside. The image processing control unit 208 controls processing of the print image to be transferred to the mechanism control unit 206. The printing control unit 209 controls image formation on a printing medium.

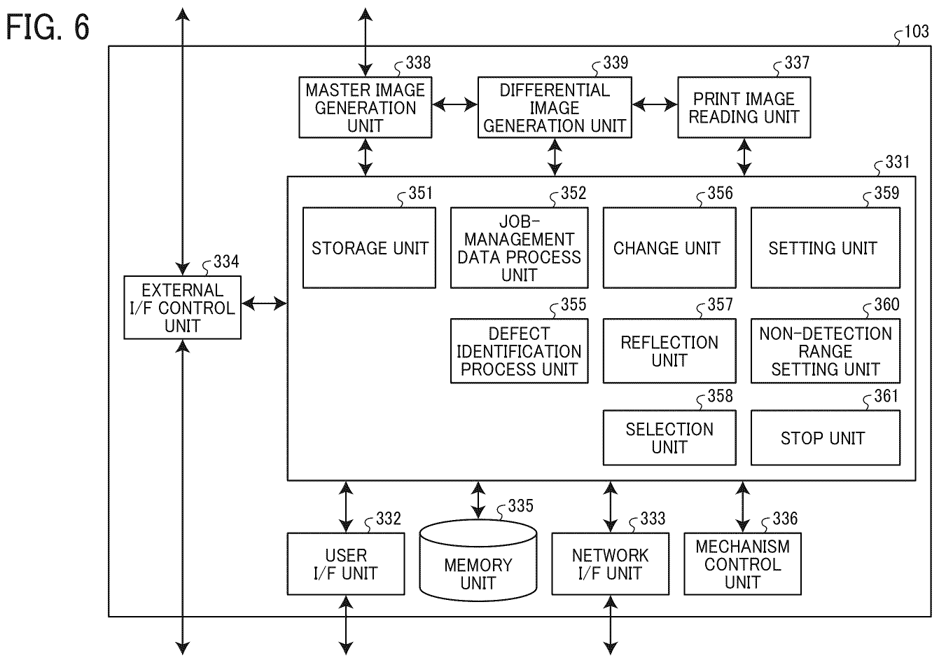

FIG. 6 is a diagram illustrating a configuration of the inspection apparatus 103. The inspection apparatus 103 includes, e.g., a system control unit 331, a user I/F unit 332, a network I/F unit 333, an external I/F control unit 334, a memory unit 335, a mechanism control unit 336, a print image reading unit 337, a master image generation unit 338, and a differential image generation unit 339.

The system control unit 331 is a control unit that controls the overall operation of the inspection apparatus 103. The user I/F unit 332 is an I/F for connecting the system control unit 331 and the operation unit 133. The network I/F unit 333 is an I/F for connecting the system control unit 331 to a network such as a LAN. The external I/F control unit 334 is an I/F with other devices. The HDD 305 is a storage device such as a hard disk. The mechanism control unit 336 is a control unit for controlling the operation such as the sheet conveyance performed by the inspection apparatus 103.

The print image reading unit 337 includes, e.g., the reading devices 131 and 132, reads a print output (print sheet), and outputs an image (inspection target image) obtained by reading the print sheet.

The system control unit 331 receives print management information via the external I/F control unit 334, stores the print management information in a memory unit 351 in the system control unit 331, extracts post processor processing information from the job management information in a job management data processing unit 352. The system control unit 331 transmits the post processor processing information to the stacker 104 which is a post processing apparatus in a subsequent stage of the inspection apparatus 103 via the external I/F control unit 334. The system control unit 331 extracts the print management information, and transfers the print management information to the master image generation unit 338, the differential image generation unit 339, the print image reading unit 337, and the mechanism control unit 336. The print management information transferred at this time is the job management information from which the post processor processing information is removed.

The master image generation unit 338 generates a master image from the RIP image. The differential image generation unit 339 generates a difference image between the master image and the inspection target image.

The system control unit 331 includes, e.g., the memory unit 351, the job management data processing unit 352, a defect identification process unit 355, a change unit 356, a reflection unit 357, a selection unit 358, a setting unit 359, a non-detection range setting unit 360, and a stop unit 361. The system control unit 331 stores the difference image between the master image and the inspection target image in the memory unit 351, and notifies the defect identification process unit 355 of the difference image. The defect identification process unit 355 determines (detects) a defect of a printed matter on the difference image by using a preset defect determination threshold (referred to as a detection level in the following description). Accordingly, the inspection apparatus 103 detects a defect of the print sheet. The defect identification process unit 355 functions as a calculation unit that performs a defect detection process to detect the defect of a print sheet for each of candidates of the minimum level, and calculates the minimum level at which the defect is detected.

The change unit 356 changes the detection level of a defect in the operation unit 133. The change unit 356 also functions as a minimum level display unit that displays the minimum level of the detection level at which a defect is detected on the operation unit 133. The selection unit 358 is a selection unit for the user to select the minimum level of a defect to be detected in the operation unit 133. The setting unit 359 is a setting unit that sets the minimum level selected by the selection unit 358 as a new detection level.

The change unit 356 may change the detection level to a detection level set by the user. In this case, the defect identification process unit 355 also functions as a re-detection unit that re-detects a defect based on the detection level set by the user. The change unit 356 functions as a detection result display unit that displays, on the operation unit 133, a detection result of a defect by the defect identification process unit 355 at the detection level set by the user. In this case, the setting unit 359 sets the detection level set by the user as the new detection level.

The change unit 356 also functions as an addition unit that newly adds a detection level or a non-detection range to the operation unit 133 when the setting of the detection level or the non-detection range described below is reflected. The change unit 356 displays whether the detection level or the non-detection range has been changed, and when the detection level or the non-detection range has been changed, the change unit 356 displays the detection level or the non-detection range before and after the change.

The non-detection range setting unit 360 is a non-detection range setting unit that sets a non-detection range for the inspection system. The non-detection range is a range in which no defect is to be detected in the print sheet. The reflection unit 357 reflects the set non-detection range on the inspection apparatus 103. For example, the non-detection range setting unit 360 may set a range from the upper, lower, left, and right ends of the print sheet to a range set by the user, as the non-detection range. Further, for example, the non-detection range setting unit 360 may set the non-detection range for a region set by the user. Further, for example, the non-detection range setting unit 360 may set the non-detection range only for a preset page. Alternatively, for example, the non-detection range setting unit 360 may set the non-detection range for all pages.

The reflection unit 357 is a reflection unit that sets a change of the detection level and reflects the setting result on the inspection apparatus 103. The reflection unit 357 reflects the setting result of the detection level on the inspection apparatus 130 without interrupting the printer 101. This allows the user to inspect a print sheet without reducing the productivity, based on the user's desired inspection level and areas that the user wants to check, thereby improving the quality of the print sheet. The inspection apparatus 103 (the defect identification process unit 355) performs, e.g., difference processing using a master image created from the print data and a scanned image obtained by reading a printed image for each detection level. There are a plurality of parameters such as a difference-correction-level determination threshold value for setting a detection level (detection sensitivity) for the difference, and a threshold value of density and size to be used when detecting a defect such as a dot or a streak. The parameters in a comma separated values (CSV) format according to the set detection level are used. When the detection level is changed during printing of one job (a printed matter), the reflection unit 357 reads a row corresponding to the changed detection level to notify the inspection apparatus 103 (the defect identification process unit 355) of the row. Accordingly, the change in the detection level is to be reflected, without interrupting printing by using the parameter at the next timing (e.g., the next page). Similarly, the addition and processing of the non-detection range are performed at a timing at which the change of the non-detection range is to be reflected. In addition, the printer and the print job reflect the detection level and the non-detection range without stopping any of the printer and the print job. A change screen is displayed during printing of the print job, and the change of the parameter to be used and the addition of the non-detection range are performed according to the respective settings at a timing at which the change and the addition is to be reflected (e.g., between pages in one copy of one print job, between copies of the print job, or between print jobs). Therefore, when the detection level is changed or the non-detection range is set during printing of the printed matter, the reflection unit 357 notifies the inspection apparatus 103 of the changed detection level or the set non-detection range. Additionally, the inspection apparatus 103 (the defect identification process unit 355) may perform the defect detection using the changed detection level or the set non-detection range at the next timing of printing of the printed matter (e.g., the next page, the next copy, or the next job).

The reflection unit 357 may immediately reflect the setting results of the detection level and the non-detection range. Alternatively, the reflection unit 357 may reflect the setting results of the detection level and the non-detection range from the next copy. Alternatively, the reflection unit 357 may reflect the setting results of the detection level and the non-detection range from the next job.

The stop unit 361 is a stopping unit that temporarily stops the printer 101 when a defect is detected by the inspection apparatus 103. The reflection unit 357 sets the detection level and the non-detection range while the printer 101 is stopped. The printer 20 resumes the printing when the settings of the detection level and the non-detection range are reflected.

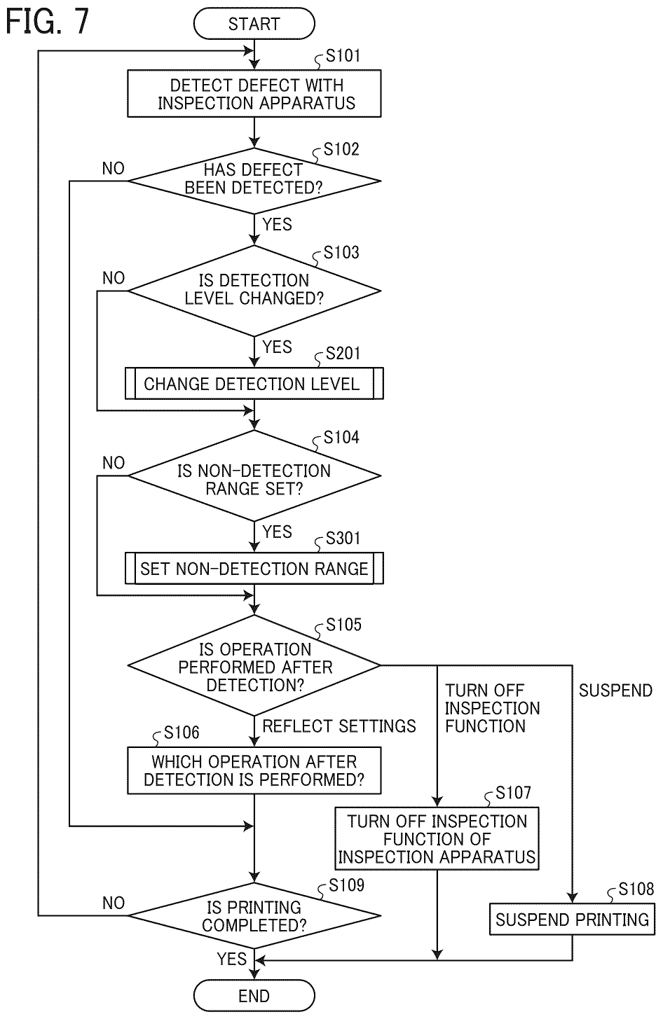

FIG. 7 is a flowchart illustrating an inspection process executed by the inspection apparatus 103. In step S101, the inspection apparatus 103 reads a printed matter (print sheet) to perform, e.g., defect detection of the print sheet. In step S102, when a defect is detected by the inspection apparatus 103 (the defect identification process unit 355) (Yes in step S102), the user can select change of the detection level (step S103), setting of the non-detection range (step S104), and selection of an operation after the defect detection (step S105).

When the detection level is changed (Yes in step S103), in step S201, the inspection apparatus 103 (the change unit 356) performs a process of changing the detection level (a detection level change process). When the non-detection range is set (Yes in step S104), in step S301, the inspection apparatus 103 (the non-detection range setting unit 360) performs a process of setting the non-detection range (non-detection range setting process).

In the detection level change process (step S201) and the non-detection range setting process (step S301), the detection result of the defect after the detection level change process or the non-detection range setting process is displayed for the page (page of the printed matter) in which the defect is detected. This enables the detection of a defect to be performed on the data stored when the defect is detected, instead of printing the data again.

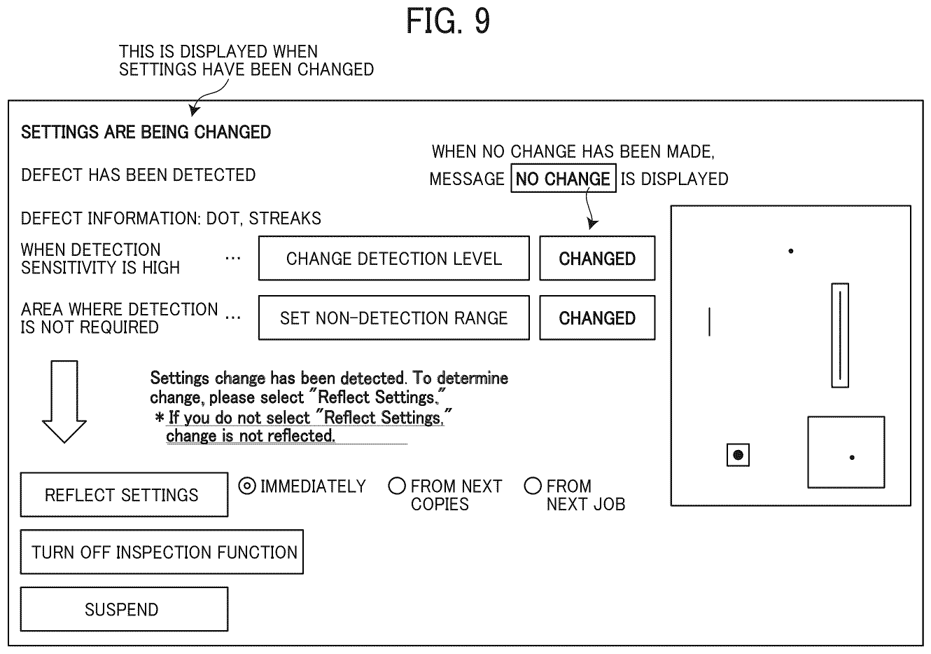

When the detection level change process (step S201) or the non-detection range setting process (step S301) is performed, the inspection apparatus 103 (the change unit 356) notifies that the setting (the inspection level change process or the non-detection range setting process) is performed on the printer 101 (the printing machine) or the operation unit 133 (the UI screen). For example, when the printer 101 (the printing machine) has a lamp, the inspection apparatus 103 (the change unit 356) displays the lamp in a color that indicates that the setting is in progress. Alternatively, for example, the inspection apparatus 103 (the change unit 356) may display that the setting is being performed on the UI screen displayed by the operation unit 133. In addition, the inspection apparatus 103 may notify the user that these settings are not reflected unless “REFLECT SETTINGS” of the operation after detection (step S105) is selected on the screen (see FIG. 9).

In the operation after the detection (step S105), when “REFLECT SETTINGS” is selected, the inspection apparatus 103 (reflection unit 357) can reflect the setting at any selected timing of immediately, from the next copy, and from the next job (step S106). In addition, the selection of “REFLECT SETTINGS” may cause to notify the user that the setting is reflected from the set timing (e.g., XX page).

When “IMMEDIATELY” is selected and “REFLECT SETTINGS” is selected, the inspection apparatus 103 (the change unit 356) may display the first page on which the setting may be reflected as “XX page to reflect.” The user may also apply the detection level change process (step S201) and the non-detection range setting process (step S301) to the result of the page before the XX page and check the result. In the operation after the detection (step S105), it is also possible to select the turning off of the verification function of the verification apparatus 103 (step S107) or the interruption of the printing (step S108).

In the interruption of the printing (step S108), for example, it is possible to perform machine learning to learn that the detection result of a certain defect is an abnormality of a certain component of the machine, and recommend interruption and maintenance or automatically execute interruption and maintenance.

When the printing is not completed in the reflection of the setting in step S106 (No in step S109), in step S101, the inspection apparatus 103 (the defect identification processing unit 355) continuously operates to detect a defect. In a case where the checking function of the inspection apparatus 103 is turned off (step S107) or printing is interrupted (step S108), the operation of the inspection apparatus 103 is ended.

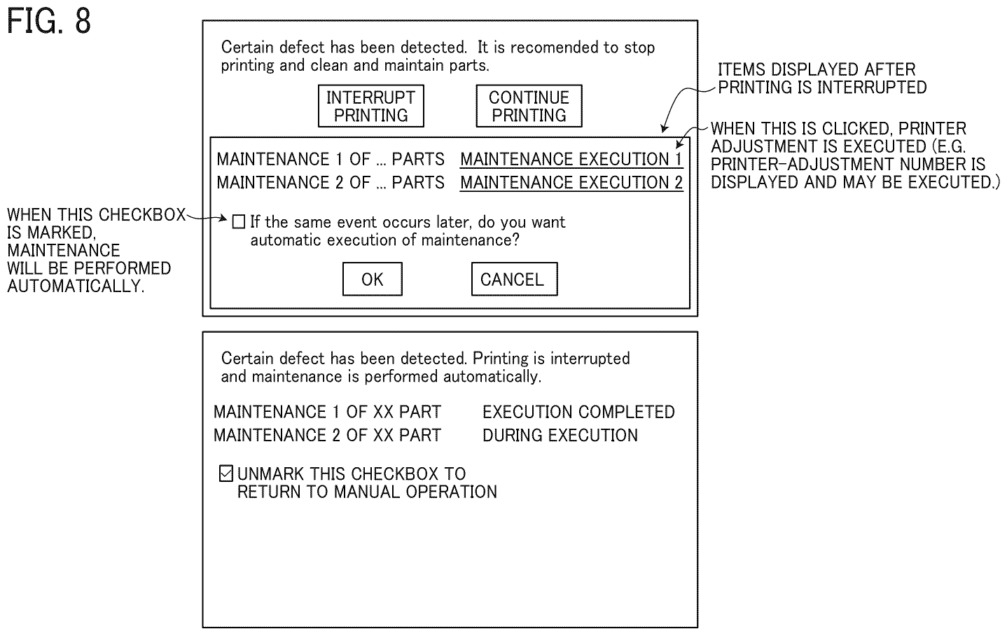

FIG. 8 is a diagram illustrating processing for causing the user to select a method of recommending or automatically executing the interruption of printing and maintenance for a specific defect by using machine learning in the inspection apparatus 103. When a defect of a print sheet is detected by the inspection apparatus 103, the printer 101 displays, on the operation unit 102, a maintenance execution button (e.g., an “OK” button) for a component in which an abnormality may have occurred after printing is interrupted. When the user presses an execution button, the printer 101 executes the maintenance.

Further, when the user checks the check box, the printer 101 transitions to an automatic execution mode for automatically executing maintenance in a case where a similar defect occurs later. In the automatic execution mode, the interruption of printing and maintenance are automatically performed. At this time, the user can check up to which maintenance has been completed. By unchecking the check box, the printer 101 may be switched to a manual execution mode in which maintenance is manually executed.

FIG. 9 is a diagram illustrating a UI when the inspection-level changing process and the non-detection range setting process are performed in the inspection apparatus 103. In a case where the detection level is changed or the non-detection range is set in the inspection level change process or the non-detection range setting process, the change unit 356 displays “changed” on the operation unit 133 (UI screen). When no change is made, the change unit 356 displays “no change.” When either the detection level or the non-detection range is changed or set, the change unit 356 displays, on the operation unit 133 (UI screen), a message indicating that the setting or the change is being performed and a message indicating that the change is not reflected unless “REFLECT SETTINGS” is selected.

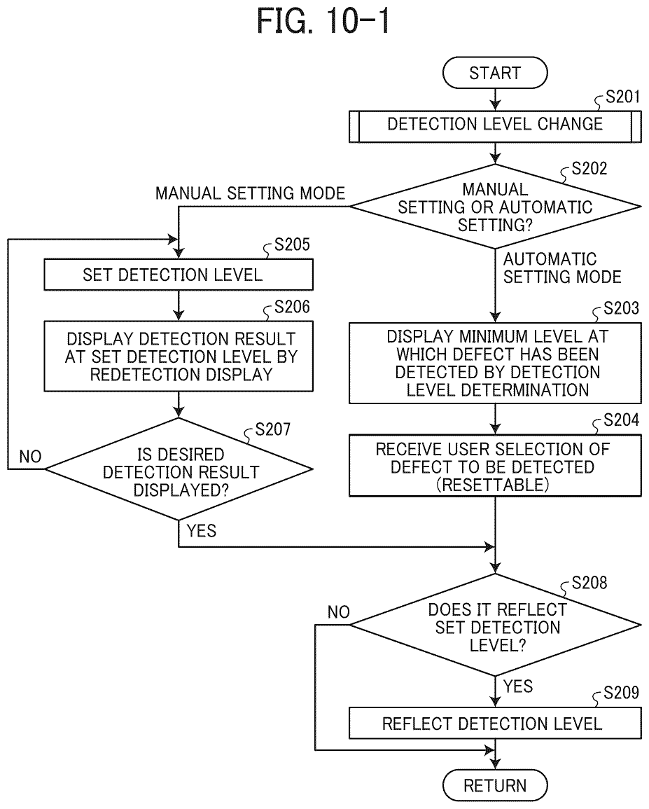

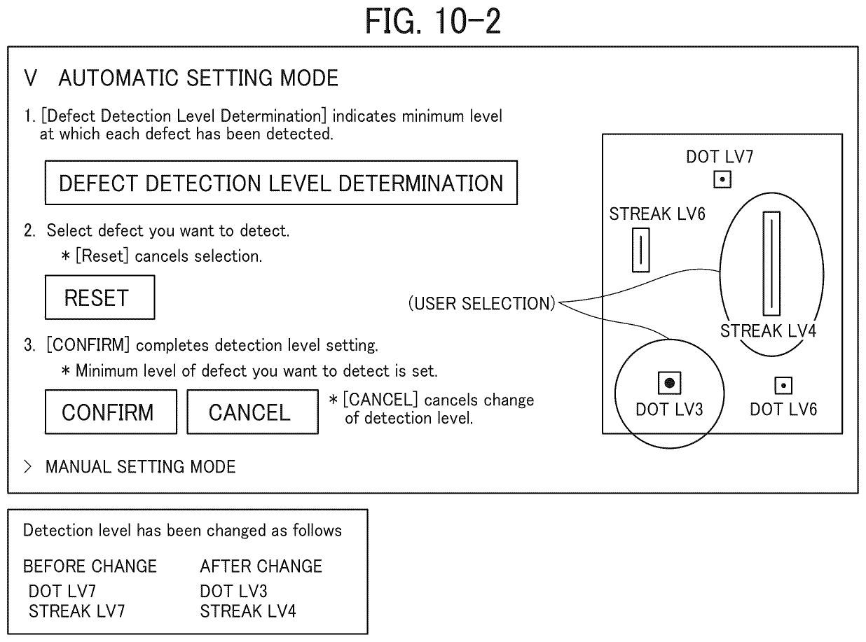

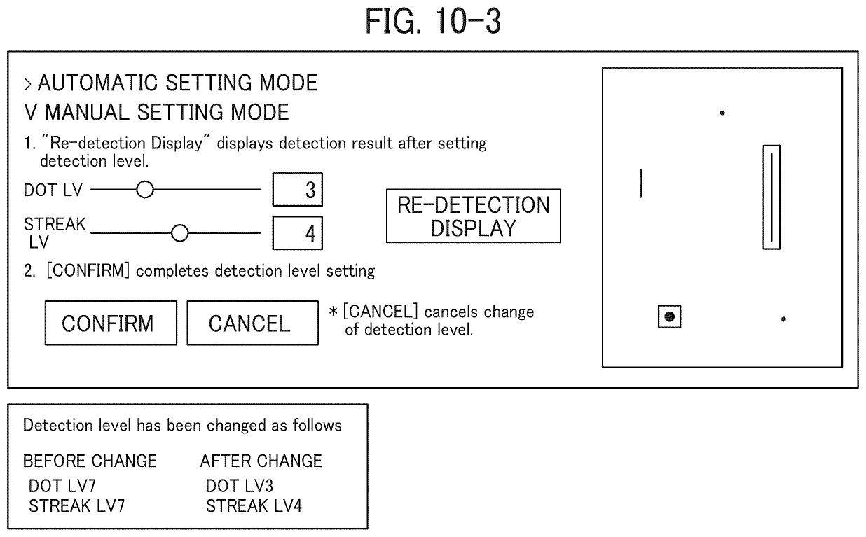

FIGS. 10-1 to 10-3 are diagrams illustrating a process of changing a detection level in the inspection apparatus 103. To be specific, FIG. 10-1 is a diagram illustrating the process illustrated in the step S201 in FIG. 7.

In step S202, the user can select an automatic setting mode in which the detection level is automatically set or a manual setting mode in which the user sets the detection level. When the automatic setting mode is selected (automatic setting mode in step S202), in step S203, the change unit 356 displays the minimum level at which each defect is detected by pressing the determination of the detection level. For example, as illustrated in FIG. 10-2, when a “DEFECT DETECTION LEVEL DETERMINATION” button displayed on the operation unit 133 is pressed, the defect identification process unit 355 performs defect detection at each detection level, and displays the minimum level at which each defect was detected on the operation unit 133. The user selects a defect to be detected.

When the user selects a defect to be detected in step S204, the change unit 356 changes the detection level to a target detection level. In step S204, the user can cancel the selection of the defect by resetting the selected defect. For example, the selection of the minimum level may be canceled by pressing a “RESET” button illustrated in FIG. 10-2. When “CONFIRM” illustrated in FIG. 10-2 is pressed, the setting unit 359 completes the setting of the detection level, and the detection levels before and after the change are displayed on the operation unit 133 on a completion screen. The change of the detection level may be canceled by pressing a “CANCEL” button illustrated in FIG. 10-2.

On the other hand, when the manual setting mode is selected (manual setting mode in step S202), in step S205, the user can set each detection level. When the user presses the display of re-detection, in step S206, the change unit 356 displays the detection result of the defect at the detection level set by the user on the operation unit 133. For example, as illustrated in FIG. 10-3, the user can set each detection level, and the defect identification process unit 355 performs defect detection again by pressing a “RE-DETECTION DISPLAY” button. In step S207, the user checks whether the detection result is a desired defect detection result, and when the detection result is not the desired defect detection result (No in step S207), in step S205, the user can set each detection level again (step S205). For example, as illustrated in FIG. 10-3, when the user can set the detection level as intended, the setting unit 359 completes the setting of the detection level by pressing a “OK” button, and the detection levels before and after the change are displayed on a completion screen. The change of the detection level may be canceled by pressing a “CANCEL” button illustrated in FIG. 10-3.

In each of the automatic setting mode and the manual setting mode, when the set detection level is reflected (Yes in step S208), the reflection unit 357 reflects the detection level, and, in step S209, the user checks the detection level before reflection and the detection level after reflection.

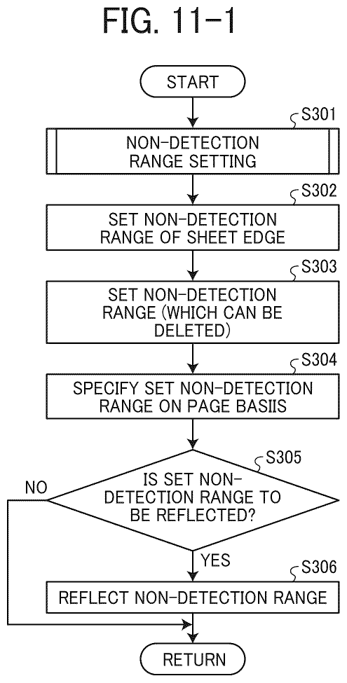

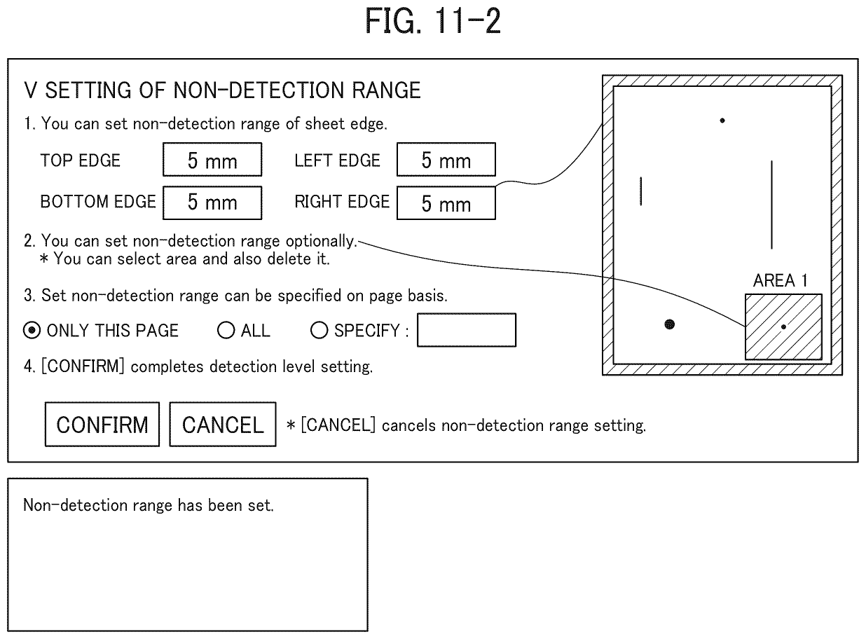

FIGS. 11-1 and 11-2 are diagrams illustrating a process of setting a non-detection range in the inspection apparatus 103. To be specific, FIG. 11-1 is a diagram illustrating the process illustrated in the step S301 in FIG. 7.

In step S302, the non-detection range setting unit 360 sets a range from the sheet edge to be set as a non-detection range. Further, the user can set an arbitrary non-detection range. In step S303, the non-detection range setting unit 360 may also delete the set non-detection range. For example, as illustrated in FIG. 11-2, the user can set the non-detection range of the upper, lower, left, and right ends in the operation unit 133. As illustrated in FIG. 11-2, the user can set a non-detection range for any desired region. Further, any desired region may be selected as the non-detection range, and the non-detection range may be deleted. The non-detection range setting unit 360 may designate the above-described set non-detection range in units of pages. Specifically, the non-detection range setting unit 360 may set the non-detection range by designating only the set page, all pages, or a plurality of designated pages. When the user presses a “CONFIRM” button illustrated in FIG. 11-2, the setting of the non-detection range is completed, and a completion screen is displayed.

In step S304, the reflection unit 357 determines whether to reflect the non-detection range set in step S302 and the non-detection range set by the user in step S303 from only this page, all pages, and the designated page. When the set non-detection range is reflected (Yes in step S305), the reflection unit 357 reflects the set non-detection range, and, in step S306, the user can check how and in which page the non-detection range is set.

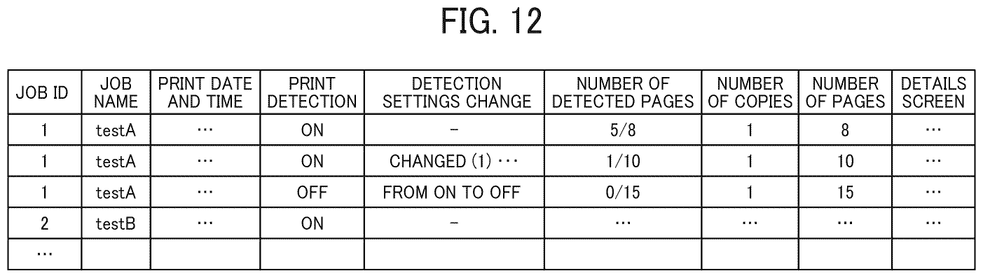

FIG. 12 is a diagram illustrating a screen of a detection log of a defect of the inspection apparatus 103.

When the change of the detection level or the setting of the non-detection range is reflected, the change unit 356 newly adds a detection log of the defect to the screen displayed on the operation unit 133, and the changed content is described in the change field of the setting of, e.g., the detection level, as illustrated in FIG. 12. The change unit 356 adds a “XX” button to a field in which, e.g., the detection level has been changed, and the settings before and after the change are displayed by pressing the “XX” button. Each time a change in the setting of, e.g., the detection level is reflected, the change unit 356 adds the content of the newly changed detection level, and assigns a number to each of the detection levels.

When the defect detection function is turned off, a new detection log is similarly added to the change unit 356, and the content of the detection log that has been turned off is described. This enables the user to check at which timing the detection level and the non-detection range are set.

As described above, the inspection apparatus 103 inspects a print sheet without reducing the productivity for a portion that a user wants to check at a desired detection level, and enhance the quality of the print sheet.

The program executed by the inspection apparatus 103 according to the present embodiment is provided by being incorporated in, e.g., a ROM in advance.

The program executed by the inspection apparatus 103 may be recorded in a computer-readable recording medium such as a CD-ROM, a flexible disk (FD), a CD-R, or a DVD in a file of an installable format or an executable format and provided.

Furthermore, the program executed by the inspection apparatus 103 may be stored in a computer connected to a network such as the Internet and provided by being downloaded via the network. The program executed by the inspection apparatus 103 may be provided or distributed via a network such as the Internet.

The program executed by the inspection apparatus 103 has a module configuration including the above-described respective units (the job management data processing unit 352, the defect identification process unit 355, the change unit 356, the reflection unit 357, the selection unit 358, the setting unit 359, the non-detection range setting unit 360, and the stop unit 361), and as actual hardware, an example of a processor such as a CPU reads the program from the ROM and executes the program, so that the respective units are loaded on a main storage device, and the job management data processing unit 352, the defect identification process unit 355, the change unit 356, the reflection unit 357, the selection unit 358, the setting unit 359, the non-detection range setting unit 360, and the stop unit 361 are generated on the main storage device.

The present disclosure has been made in consideration of the above situation, and provides an inspection system, an inspection method, and a non-transitory recording medium capable of inspecting a printed matter without lowering productivity for a portion that a user wants to check at an ideal detection level, and enhancing the quality of the printed matter.

According to the present disclosure, it is possible to inspect a printed matter without reducing the productivity for a portion that a user wants to see at an ideal detection level, and enhance (reduce) the quality of the printed matter.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An inspection system comprising:
an image forming apparatus to form an image on a printed matter; and
an inspection apparatus to detect a defect of the printed matter, the inspection apparatus including;
a display to display the defect; and
circuitry configured to:
change a detection level of the defect at the display;
set a change of the detection level; and
reflect a setting result of the detection level on the inspection apparatus without interrupting operation of the image forming apparatus.

2. The inspection system according to claim 1, wherein the circuitry is further configured to:
display, on the display, one or more candidates of a minimum level of the detection at which the defect is detected;
select, from among the candidates on the display, the minimum level of the defect according to the user preference; and
set the minimum level that is selected as a new detection level.

3. The inspection system according to claim 2, wherein the circuitry is further configured to:
detect the defect for each of the one or more candidates of the minimum level; and
calculate the minimum level at which the defect is detected.

4. The inspection system according to claim 2, wherein the detection level is set by a user, and the circuitry is configured to:
detect the defect again based on the detection level set by the user;
display a detection result of the defect that is detected again at the detection level set by the user; and
set the detection level set by the user as a new detection level.

5. The inspection system according to claim 1, wherein the circuitry is further configured to:
set a non-detection range; and
reflect the set non-detection range on the inspection apparatus.

6. The inspection system according to claim 5,
wherein the circuitry sets, as the non-detection range, a range from upper, lower, left, and right ends of the printed matter to a range set by a user.

7. The inspection system according to claim 5,
wherein the circuitry sets the non-detection range for a region set by a user.

8. The inspection system according to claim 5,
wherein the circuitry sets the non-detection range only on a preset page of the printed matter.

9. The inspection system according to claim 5,
wherein the circuitry sets the non-detection range for all pages of the printed matter.

10. The inspection system according to claim 5,
wherein the circuitry immediately reflects a setting result of the detection level and the non-detection range.

11. The inspection system according to claim 5,
wherein the circuitry reflects the setting results of the detection level and the non-detection range from a following copy of the printed matter.

12. The inspection system according to claim 5,
wherein the circuitry reflects the setting results of the detection level and the non-detection range from a following job that follows a current job for forming the image.

13. The inspection system according to claim 5, wherein the circuitry is configured to
stop the image forming apparatus once when the inspection apparatus detects the defect, and
set the detection level and the non-detection range during the stop of the image forming apparatus,
wherein the image forming apparatus resumes forming an image when the settings of the detection level and the non-detection range have been reflected.

14. The inspection system according to claim 5,
wherein the circuitry is further configured to additionally display the detection level or the non-detection range on the display when the setting of the detection level or the non-detection range is reflected, and
display an indicator of whether the detection level or the non-detection range is changed, and
when the detection level or the non-detection range is changed, display the detection level or the non-detection range before and after the change.

15. The inspection system according to claim 5,
wherein, when the detection level has been changed or the non-detection range has been set during printing of the printed matter,
the circuitry performs the detection of the defect using the changed detection level or the set non-detection range at a time after printing of the printed matter.

16. An inspection method comprising:
displaying, on a display, a defect of a printed matter formed by an image forming apparatus, the defect being detected by an inspection apparatus;
changing a detection level of the defect;
setting a change of the detection level; and
reflecting a setting result of the detection level on the inspection apparatus without interrupting operation of the image forming apparatus.

17. A non-transitory recording medium storing a plurality of instructions which, when executed by one or more processors, causes the one or more processors to perform an inspection method comprising:
displaying, on a display, a defect of a printed matter formed by an image forming apparatus, the defect being detected by an inspection apparatus;
changing a detection level of the defect;
setting a change of the detection level; and
reflecting a setting result of the detection level on the inspection apparatus without interrupting operation of the image forming apparatus.
